(19) United States
(12) Patent Application Publication
(10) Pub. No.: US 2023/0111115 A1
(43) Pub. Date: Apr. 13, 2023

(54) IDENTIFYING A CONTRIBUTION OF AN INDIVIDUAL ENTITY TO AN OUTCOME VALUE CORRESPONDING TO MULTIPLE ENTITIES

(71) Applicant: Oracle International Corporation, Redwood Shores, CA (US)

(72) Inventor: Karempudi V. Ramarao, San Ramon, CA (US)

(73) Assignee: Oracle International Corporation, Redwood Shores, CA (US)

(21) Appl. No.: 17/449,299

(22) Filed: Sep. 29, 2021

(51) Int. Cl. G06Q 10/06; G06Q 30/02; G06N 20/00

(52) U.S. Cl. CPC G06Q 10/06398; G06N 20/00; G06Q 30/0201

(57) ABSTRACT

Techniques are disclosed for determining individual contributions of corresponding individual entities that cooperatively contribute to accomplishing a goal or outcome. One technique determines an individual contribution of a target entity to an overall outcome value by identifying a first sequence of entities that includes the target entity and a corresponding sequence outcome value. Other sequences and their corresponding outcome values may be identified that partially match the first sequence while excluding the target entity. The outcome values for the other sequence(s) may be removed from the outcome value of the first sequence, thereby isolating the individual contribution of the target entity.

### TECHNICAL FIELD

The present disclosure relates to improving computing-based analysis of large data sets. In particular, the present disclosure relates to identifying a contribution of an individual entity to an outcome value corresponding to multiple entities.

### BACKGROUND

Identifying contributions of individual components toward a collective goal can be derived using principles of game theory. One specific example is that of the Shapely Value Theory. The Shapley value may identify relative contributions of individuals to a common goal (e.g., in a cooperative game). The Shapley value may be calculated by first identifying each combination of the individual contributors in a set (e.g., players on a team) and associated “worth” values. A set of contributors and a corresponding “worth” value is identified up to and including a particular individual contributor of interest, in this case denoted as contributor “i.” In the example of players on a team playing a cooperative game, the worth value may be a number of points scored by players “a,” “b,” “c,” and “i.” To determine the individual (or “marginal”) worth of “i,” another collective worth of a sub-set of all the contributors up to “i” (“a,” “b,” “c,”) is identified. The worth value of the sub-set that does not include contributor “i” is subtracted from the worth value of the set of contributors that does include the contributor “i” as the last contributor in the set. This gives the marginal contribution from player i in that permutation of contributors. This process is repeated for each permutation of the set and finally the average over all permutations is determined as the contribution by ‘i’.

However, applying the Shapley Value Theory requires certain conditions and attributes that are not easily met, particularly when analyzing real-world datasets that may have thousands of attributes and/or attribute values. For example, calculating a Shapley value generally requires a low number of contributors. This is rarely found in real world computing applications that have thousands of attributes being analyzed. Also, the Shapley value calculation requires knowing the worth of all possible sub-sets of contributors in advance so that the contribution of each component may be inferred from the worth of various combinations of contributors. This is also rarely the case in real-world applications.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for identifying an individual contribution of an entity to an overall outcome associated with a sequence of entities in accordance with one or more embodiments;

FIGS. 3A-3D illustrates one example embodiment of some of the operations illustrated in FIG. 2 in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. DETERMINING ATTRIBUTION FOR INDIVIDUAL ENTITIES
4. EXAMPLE EMBODIMENT
5. COMPUTER NETWORKS AND CLOUD NETWORKS
6. MISCELLANEOUS; EXTENSIONS
7. HARDWARE OVERVIEW

### 1. General Overview

Embodiments determine the individual contributions of corresponding individual entities (or factors) that cooperatively contribute to accomplishing a goal or outcome. The system may identify these individual entity contributions for outcomes in situations where individual entity contributions are not known or cannot be separately quantified.

In one example, a system determines an individual contribution of a target entity in a chronological sequence of entities that contributed to a particular outcome value. The chronological sequence of entities includes entities in a chronological order based on when each entity contributed to the particular outcome value. The system identifies a sub-sequence of two or more entities, in the chronological sequence of entities, that (a) includes entities other than the target entity and (b) is associated with another outcome with a corresponding known outcome value. The system determines the contribution of the target entity by removing the known outcome value, associated with the sub-sequence of two or more entities, from the particular outcome value corresponding to the chronological sequence of entities.

One or more embodiments described in this Specification and/or recited in the claims may not be included in this General Overview section.

### 2. System Architecture

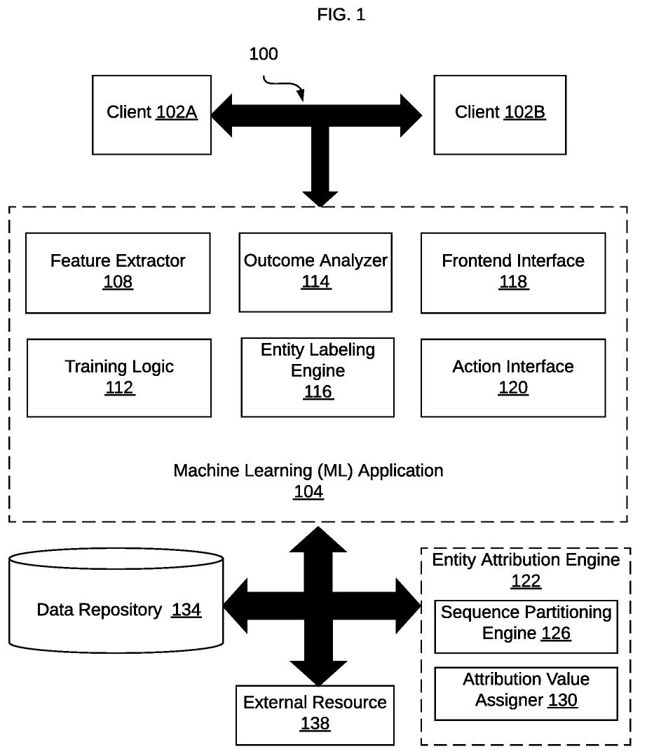

FIG. 1 illustrates a system 100 in accordance with one or more embodiments. As illustrated in FIG. 1, system 100 includes clients 102A, 102B, a machine learning (ML) application 104, entity attribution engine 122, data repository 134, and an external resource 138. In one or more embodiments, the system 100 may include more or fewer components than the components illustrated in FIG. 1.

The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The clients 102A, 102B may be a web browser, a mobile application, or other software application communicatively coupled to a network (e.g., via a computing device). The clients 102A, 102B may interact with other elements of the system 100 directly or via cloud services using one or more communication protocols, such as HTTP and/or other communication protocols of the Internet Protocol (IP) suite.

In some examples, one or more of the clients 102A, 102B are configured to receive and/or generate data items that are processed by the ML application 104 and/or analyzed by the entity attribution engine 122. The ML application 104 may process and/or analyze the transmitted data items by applying one or more trained ML models to the received data items. In some examples, the ML application 104 may process and/or analyze by inferring outcome values and/or determining sub-population attributes of a population (or set) of data. In some embodiments used to illustrate the techniques described herein, the data analyzed are those received in a marketing campaign. In some examples, the entity attribution engine 122 may identify entity sequences and/or sub-sequences of entities, their corresponding outcome values, and use these data to determine individual entity contributions to a particular outcome value for a corresponding particular entity sequence. In some examples, data items received and/or generated by the clients 102A, 102B are stored in the data repository 134.

The clients 102A, 102B may also include a user device configured to render a graphic user interface (GUI) generated by the ML application 104 and/or entity attribution engine 122. The GUI may present an interface by which a user triggers execution of computing transactions, thereby generating and/or analyzing data items. In some examples, the GUI may include features that enable a user to view training data, classify training data, and other features of embodiments described herein.

Furthermore, the clients 102A, 102B may be configured to enable a user to provide user feedback via a GUI regarding the accuracy of the analysis performed by the ML application 104 and/or the entity attribution engine 122. That is, a user may label, using a GUI, an analysis generated by the ML application 104 as accurate or not accurate, thereby further revising or validating training data. This latter feature enables a user to label target data analyzed by the ML application 104 so that the ML application 104 may update its training data set with analyzed and labeled target data.

The clients 102A, 102B may also use entity attribution analysis data generated by the entity attribution engine 122 to update, revise, and/or improve the quality of training data. As described below, weights and/or labels of feature vector parameters may be based on, or adjusted in light of, individual entity contributions toward an output value. In some examples, the weights/labels associated with a feature vector and/or the constituent parameters of a feature vector may be associated with the vector representation of a sequence of entities.

The ML application 104 of the system 100 may be configured to train one or more ML models using training data, prepare target data before ML analysis, and analyze data to generate an outcome value corresponding to a sequence of entities. In some examples, the ML application 104 may prepare data for processing by the entity attribution engine 122 and update training data based on analytical output from the entity attribution engine 122.

The machine learning application 104 includes a feature extractor 108, training logic 112, an outcome analyzer 114, an entity labeling engine 116, a frontend interface 118, and an action interface 120.

The feature extractor 108 may be configured to identify characteristics associated with data items. The feature extractor 108 may generate corresponding feature vectors that represent the identified characteristics. For example, the feature extractor 108 may identify attributes within training data and/or “target” data that a trained ML model within the ML application 104 (e.g., within outcome analyzer 114 and/or entity labeling engine 116) is directed to analyze. Once identified, the feature extractor 108 may extract characteristics from one or both of training data and target data.

The feature extractor 108 may tokenize some data item characteristics into tokens. The feature extractor 108 may then generate feature vectors that include a sequence of values, with each value representing a different characteristic token. In some examples, the feature extractor 108 may use a document-to-vector (colloquially described as “doc-to-vec”) model to tokenize characteristics (e.g., as extracted from human readable text). The feature extractor may generate feature vectors corresponding to one or both of training data and target data. The example of the doc-to-vec model is provided for illustration purposes only. Other types of models may be used for tokenizing characteristics.

For example, the feature extractor 108 may use a clustering model or other type of trained ML model to generate one or more feature vectors representing population characteristics of recipients of a marketing campaign, characteristics of a sequence of marketing events provided to one or more recipients, and/or characteristics of the responses received from the recipients. More generally, any type of ML model may generate feature vectors/tokens to represent entity values.

The feature extractor 108 may append other features to the generated feature vectors. In one example, a feature vector may be represented as [f₁, f₂, f₃, f₄], where f₁, f₂, f₃ correspond to characteristic tokens and where f₄ is a non-characteristic feature. Example non-characteristic features may include, but are not limited to, a label quantifying a weight (or weights) to assign to one or more characteristics of a set of characteristics described by a feature vector. In some examples, a label may indicate one or more classifications associated with corresponding characteristics.

One illustration of this labeling aspect is that the entity attribution engine 122 may determine a particular individual contribution of a particular attribute that corresponds to a token in a feature vector. Once the entity attribution engine 122 determines this individual contribution, the entity attribution engine 122 may provide the contribution to one or both of the feature extractor 108 and/or training logic 112. The system may use the determined individual entity attribution value to adjust a corresponding token weight in proportion to the determined contribution. In this way, the entity attribution engine 122 may improve the accuracy and precision of training data based on an analysis of target data.

The feature extractor 108 may optionally be applied to new data (yet to be analyzed) to generate feature vectors from the new data. These new data feature vectors may facilitate analysis of the new data by one or more ML models, as described below. In some of the examples described here, the “new” data may be that of a user engagement data in response to electronically transmitted marketing data entities. Examples of electronically transmitted marketing data entities include but are not limited electronically rendered advertisements, emails, electronically executed voice communications, among others. The feature extractor 108 may represent received user engagement data as a vector composed of tokens that indicate, for example, sub-populations of users (e.g., according to demographic data), types and quantities of transmitted marketing data entities, and corresponding response rates.

In some examples, training data used by the training logic 112 to train the machine learning engine 110 includes feature vectors of data items that are generated by the feature extractor 108, described above.

The training logic 112 may be in communication with a user system, such as clients 102A, 102B. The clients 102A,102B may include an interface used by a user to apply labels to the electronically stored training data set.

The training logic 112 may train machine learning (ML) models employed by the ML application 104 using feature vectors generated by the feature extractor 108 in some examples. Regardless of the source of training data, the trained models employed by the ML application 104 may be applied to target data to analyze and/or characterize the target data.

In one embodiment of the system 100, one or both of the outcome analyzer 114 and the entity labeling engine 116 may be instantiated as a trained ML model. At a high level, the trained ML models may include one or both of supervised machine learning algorithms and unsupervised machine learning algorithms. In some examples, the trained ML models may include any one or more of linear regression, logistic regression, linear discriminant analysis, classification and regression trees, naive Bayes, k-nearest neighbors, learning vector quantization, support vector machine, bagging and random forest, boosting, back propagation, and/or clustering models. In some examples, multiple trained ML models of the same or different types may be arranged in a ML “pipeline” so that the output of a prior model is processed by the operations of a subsequent model. In various examples, these different types of machine learning algorithms may be arranged serially (e.g., one model further processing an output of a preceding model), in parallel (e.g., two or more different models further processing an output of a preceding model), or both.

In some embodiments, the outcome analyzer 114 and/or the entity labeling engine 116 may be instantiated as a neural network, sometimes also referred to as a deep learning model. A neural network uses various “hidden” layers of multiple neurons that successively analyze data provided via an input layer to generate a prediction via an output layer. A neural network may be used instead of or in cooperation with any of the other models listed above, all of which may be adapted to execute one or more of the operations described herein. Other configurations of a trained ML model used to perform the functions of one or both of the outcome analyzer 114 and/or the entity labeling engine 116 may include additional elements or fewer elements.

For clarity, the following paragraphs present examples of “entities” as analyzed by the system 100. Examples of an entity may include any number of different types of data structures. In its most general sense, an entity is a discrete representation of one or more attributes and/or corresponding attribute values that are associated with one another. In one example, an entity may be a collection of attributes characterizing a particular corresponding event. In this way, the entity may be used to analyze the corresponding event using some of the techniques described below.

In one example, an entity may be instantiated as a row and/or a table data structure that stores attribute values for a corresponding event. In another example, an entity may be instantiated as a collection of metadata that describes the various attributes/attribute parameters. In still another example, an entity may be instantiated as a feature vector and/or a feature token. In yet another example, an entity may be instantiated as a plain text file (e.g., a “flat file”) or a binary file that may be processed, compiled, or otherwise rendered by executable code. In still another example, an entity may be a multi-component data structure that includes binary data that is rendered upon execution of object-oriented code (e.g., JAVA®) embedded in the entity along with the binary data. Other data entities may include combinations of any of these data structures.

In one illustration, an entity may be a collection of attributes describing a particular marketing campaign event, such as a promotional email distribution. In this example, the attributes could include a number of transmitted emails associated with a discrete mailing (e.g., distributed in a first campaign event during a defined window of time), key words that represent a summary or title of the discrete mailing (“10% discount on tents,” or “first month free”), and attributes describing the recipients (e.g., demographic and/or geographic data). In this example, these attributes and their corresponding values are stored in a table data object that is conveniently transmitted and/or analyzed according to the techniques described herein.

The outcome analyzer 114 may determine outcome value associated with a sequence of entities and/or sub-sequence of entities in target data. These values may be used to determine a contribution of an individual entity to a sequence outcome value, as described below. As indicated above, the outcome analyzer 114 may be instantiated using a trained ML model. The outcome analyzer 114 may use its trained ML model capabilities to identify entities and their associated sequences based on an ML analysis of associated entity attributes.

To illustrate the utility of using a trained ML model as the outcome analyzer 114, some embodiments to which the system 100 may be applied involve the reception of millions of entities throughout a measurement period from dozens or hundreds of different projects (e.g., marketing campaigns). The outcome analyzer 114 may receive individual entities as part of a, voluminous and high rate, data stream. Using a trained ML model, the outcome analyzer 114 may identify entities within the incoming stream in real time, based on a combination of attributes associated with the entities. For example, the trained ML model of the outcome analyzer 114 may detect source IP address, a sequence and/or event identifier, subject matter attributes (e.g., via a content analysis or deep packet analysis), entity metadata, entity payload data (directly related to the event represented by the entity), and/or similar attributes that characterize the event corresponding to the entity. The trained ML model of the outcome analyzer 114 may then, based on these detected entity/event attributes, assign an incoming entity to an associated sequence of entities and an associated outcome value. In this way, the outcome analyzer 114 may assemble entities in a proper order associated with one or more sequences of entities.

The outcome analyzer 114 may also separate related entities into different sequences, as reflected by different attribute values. For example, the outcome analyzer 114 may recognized that two similar entities actually are associated with different sequences and assign the data entities to their proper respective sequences. The outcome analyzer 114 may also detect that these two sequences are related to one another and store them with an association (e.g., a link) for later analysis by the entity attribution engine 122.

The entity labeling engine 116 may communicate with other elements of the system 100 to identify attributes in the training data that correspond to sequences, sub-sequences, and individual entity contribution values. In some examples, the entity labeling engine 116 may apply labels to incoming entities and/or assembled sequences and/or sub-sequences so that entities are properly weighted. In other examples, the entity labeling engine 116 may also apply labels so that sequences are properly associated with one another as part of a set of sequences.

In some examples, the entity labeling engine 116 may execute sequence labeling based on data provided by, or accessible through, the outcome analyzer 114. In some examples, the entity labeling engine 116 may apply entity labels (e.g., weights corresponding to individual contributions) based on data generated by the entity attribution engine 122.

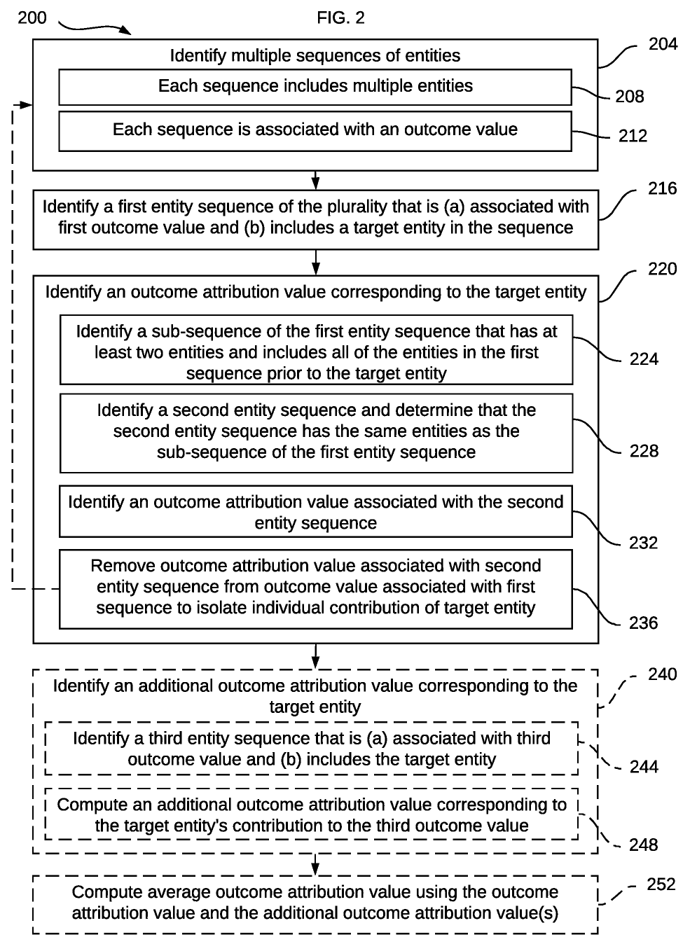

The operations executed by the outcome analyzer 114 and the entity labeling engine 116 are described in more detail in the context of FIG. 2.

The frontend interface 118 manages interactions between the clients 102A, 102B and the ML application 104. In one or more embodiments, frontend interface 118 refers to hardware and/or software configured to facilitate communications between a user and the clients 102A, 102B and/or the machine learning application 104. In some embodiments, frontend interface 118 is a presentation tier in a multitier application. Frontend interface 118 may process requests received from clients and translate results from other application tiers into a format that may be understood or processed by the clients.

For example, one or both of the client 102A, 102B may submit requests to the ML application 104 via the frontend interface 118 to perform various functions, such as for labeling training data and/or analyzing target data. In some examples, one or both of the clients 102A, 102B may submit requests to the ML application 104 via the frontend interface 118 to view a graphic user interface related to analysis of outcome data for an individual entity, a sequence of data entities, or a collective of numerous sequences of data entities. In still further examples, the frontend interface 118 may receive user input that re-orders individual interface elements.

Frontend interface 118 refers to hardware and/or software that may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

In an embodiment, different components of the frontend interface 118 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the frontend interface 118 is specified in one or more other languages, such as Java, C, or C++.

The action interface 120 may include an API, CLI, or other interfaces for invoking functions to execute actions. One or more of these functions may be provided through cloud services or other applications, which may be external to the machine learning application 104. For example, one or more components of machine learning application 104 may invoke an API to access information stored in a data repository (e.g., data repository 134) for use as a training corpus for the machine learning application 104. It will be appreciated that the actions that are performed may vary from implementation to implementation.

In some embodiments, the machine learning application 104 may access external resources 138, such as cloud services. Example cloud services may include, but are not limited to, social media platforms, email services, short messaging services, enterprise management systems, and other cloud applications. Action interface 120 may serve as an API endpoint for invoking a cloud service. For example, action interface 120 may generate outbound requests that conform to protocols ingestible by external resources.

Additional embodiments and/or examples relating to computer networks are described below in Section 5, titled “Computer Networks and Cloud Networks.”

Action interface 120 may process and translate inbound requests to allow for further processing by other components of the machine learning application 104. The action interface 120 may store, negotiate, and/or otherwise manage authentication information for accessing external resources. Example authentication information may include, but is not limited to, digital certificates, cryptographic keys, usernames, and passwords. Action interface 120 may include authentication information in the requests to invoke functions provided through external resources.

The entity attribution engine 122 detects sub-sequences of entities in target data and then applies the detected sub-sequences according to the method 200 to determine an attribution value for an individual entity in a sequence and/or sub-sequence. In the illustrated embodiment, the entity attribution engine 122 includes a sequence partitioning engine 126 and an attribution value assigner 130.

The sequence partitioning engine 126 identifies sub-sequences within the received sequence for which sub-sequence outcome data is available. For example, the sequence partitioning engine 126 may identify a particular sub-sequence within a sequence, and also identify that the particular sub-sequence is associated with an outcome value (via communication with the outcome analyzer 114). By identifying relevant target data that can be applied according to the method 200, the sequence partitioning engine prepares data for analysis according to the method 200.

The attribution value assigner 130 is configured to analyze a sequence of entities along with any identified sub-sequences that are accompanied by an outcome value. The attribution value assigner 130 may then apply these data according to the method 200 to extract an individual outcome attribution value associated with an individual entity.

In one or more embodiments, data repository 134 may be any type of storage unit and/or device (e.g., a file system, database, collection of tables, or any other storage mechanism) for storing data. Further, data repository 134 may each include multiple different storage units and/or devices. The multiple different storage units and/or devices may or may not be of the same type or located at the same physical site. Further, data repository 134 may be implemented or may execute on the same computing system as the ML application 104. Alternatively or additionally, data repository 134 may be implemented or executed on a computing system separate from the ML application 104. Data repository 134 may be communicatively coupled to the ML application 104 via a direct connection or via a network.

Information related to target data items and the training data may be implemented across any of components within the system 100. However, this information may be stored in the data repository 134 for purposes of clarity and explanation.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Determining Attribution for Individual Entities

FIG. 2 illustrates an example set of operations for determining an outcome attribution value for an individual entity in a sequence of entities in accordance with one or more embodiments. Some of the embodiments described below determine the contribution of individual entities to a shared outcome value, regardless of the number of contributing entities. The embodiments described below may determine some or all of the contributions of individual entities, whether the number of individual entities number in the tens, hundreds, thousands, or millions. Furthermore, the techniques described below may be applied to situations in which few, and in some cases none, of the individual contributions of entities are known. The embodiments may collectively use outcome value measurements associated with multiple different combinations of entities to determine individual contributions.

One or more operations illustrated in FIG. 2 may be modified, rearranged, or omitted all together. Accordingly, the particular sequence of operations illustrated in FIG. 2 should not be construed as limiting the scope of one or more embodiments.

The method 200 begins my identifying multiple sequences of data entities (operation 204), where each sequence of entities includes one or more individual data entities (operation 208).

Examples of entities are presented above in the context of the outcome analyzer 114. At a high level, as presented above, an entity is a discrete representation of one or more attributes and/or corresponding attribute values that are associated with one another. In one example, an entity may be a collection of attributes characterizing a particular corresponding event.

A sequence of data entities may be a collection of data entities that are associated with one another, either by a factual circumstance or a logical connection (operation 208).

A sequence of data entities may be instantiated as a set of individual data entities that are stored collectively and associated with one another via metadata or within a common superstructure. For example, a sequence of data entities may include a table of attributes, in which each row corresponds to an individual entity. In another example, a sequence of data entities may be instantiated as a collection of tables stored in a common file or stored using a common metadata identifier that associates the tables with one another. The tables may be rendered, converted into a feature vector, or otherwise concatenated with one another upon execution of code. In still another example, a sequence of data entities may be a feature vector within which each individual entity is separated from other entities using a delimiter (e.g., a common, a colon, a pipe, a semicolon).

In these examples, an order in which events are executed may produce different outcome values. For example, the same events executed or performed in a first order may produce a different outcome than the same events executed in a different, second order. The reference here to a “sequence” of events implies that the analysis of the various sequences and sub-sequences reflects the influence of event order (i.e., order of entities within a sequence) on an associated outcome value.

In some examples, this order in which the events are executed and the corresponding entities are arranged is chronological. In this example, each entity includes a time stamp, an order number, or other indication of the chronology or order in which the entities were generated or their corresponding events executed in order to contribute to a particular collective outcome value associated with the sequence.

Each sequence may be associated with an outcome value (operation 212). The outcome value may represent or quantify a collective result that is associated with the sequence of multiple entities described above in the context of the operation 208. In some examples, the outcome value quantifies a number of results associated with the events represented by the multiple entities in a sequence of entities. In some cases, the outcome value may be represented as a real number, such as a count or quantity of outcomes from the entities in the sequence. In other cases, the outcome value may be represented as a relative or proportional quantity, such as a percentage of a total number of entities transmitted.

More generally, the outcome value may be described generically as a function that determines by how much a counter or measurement for a desired outcome is to be incremented. The function may be based on any number of received parameters. The function may increment a counter that tracks a desired outcome based on, for example: (a) the parameters analyzed; (b) whether or not the parameters have a null value or a non-null value; and/or (c) for non-null values, the magnitude of the non-null value.

As is clear from the preceding description, the outcome values of the operation 212 are associated with a sequence of entities. That is, the system analyzes parameters/parameter values for the multiple entities in a sequence. Based on the analysis of these parameters and their corresponding parameter values for the multiple entities of the sequence, the system increments (or decrements in some cases) an outcome value associated with the sequence.

The system may execute the operation 212 on a single sequence in some cases. In other cases, the system may execute the operation 212 on any number of sequences. Generating outcome values for multiple sequences that have comparable outcome values (e.g., generated to calculate comparable outcomes or using similar parameters on which to base an outcome value) facilitates a comparison of different sequences to one another. In other words, this technique enables performance of different series of events to be compared to one another.

In some embodiments, the generation of an outcome value (and the analysis of following operations) considers an order of the entities in a given sequence. While many aspects of Game Theory (including the Shapley Value Theory) execute analyses independently of the order of entities (e.g., based on a combination of entities and not based on a permutation of entities), the operation 212 does incorporate order (permutation) into the analysis. From a practical application perspective, incorporating an order of events into the analysis accurately reflects real world conditions because in many cases events are performed with an order.

In one illustration of the importance of order, marketing campaigns that are composed of a series of events to a set of recipients (e.g., an email distribution event, a banner advertisement event, a promotional discount notice event) necessarily are executed in a particular order. In some examples, the order (i.e., the sequence) in which the events (i.e., the entities representing the events) are executed may have an impact on the rate of success. The embodiments described herein are configured to detect differences in outcome value that may be attributable to different sequences (i.e., orders) of the same events and also detect different attribution values of the same events (i.e., individual contributions toward an outcome value) when performed in different sequences. In the preceding illustration, some embodiments of the present disclosure are configured to detect a higher attribution value for an email distribution event occurring early in a first sequence of events relative to the same email distribution event occurring later in a second sequence of the same events executed in a different order than the first sequence.

An outcome value associated with a sequence is a quantification of the measured outcome resulting from the sequence as a whole. An outcome value may be associated with a desired result. For example, an outcome value may quantify a number of sales generated by a marketing event (also terms “conversions”), a number of active user engagements (e.g., opening an email, clicking on a link), and the like.

But outcome values are not limited to merely desired or positive outcomes. Embodiments of the present disclosure may analyze any type of outcome that can be quantified by an outcome value, even undesirable outcomes. For example, embodiments described herein may analyze use measurements of unresponsiveness to a marketing campaign and detect the attribution of different entities to the extent of unresponsiveness (e.g., communication type, date/time of communication, recipient demographic factors).

In some examples, a sequence may be associated with multiple different outcome values, where each outcome value measures a degree of success for different outcomes. For simplicity of explanation, the following description presumes a single outcome value but this single value may be selected from a group of outcome values.

In some examples, trained machine learning models may be applied to collect data used to generate an outcome value, prepare and/or analyze the collected data, and/or generate an outcome value for a particular sequence. In some examples, a system may employ one or more trained ML models for generating an outcome value for an associated sequence to improve the accuracy of the outcome value. In other examples, a system may employ one or more trained ML models for generating an outcome value for an associated sequence because the collection, preparation, and analysis of data is sufficiently nuanced and sophisticated that ML techniques are the only practical solution. In still other examples, the quantity of data to be analyzed to generate an outcome value is so vast that using a trained ML technique is the only practical solution.

The earlier presented illustration demonstrates the benefits of using a trained ML model to generate an outcome value for a sequence. For example, executing an electronic marketing campaign is generally far more complicated than marketing campaigns performed via physical means. Analogously, analyzing the results are far more complicated because the quantity of data acquired upon executing of a marketing campaign is exponentially greater than that for a physical media (or even broadcast media, such as television and/or radio).

Using trained ML models to execute a marketing campaign is beneficial because of the many different platforms that may be simultaneously used for electronic marketing. The channels by which electronic marketing materials are distributed include, but are not limited to, direct contact via communications to an address (email, text), social media, banner advertisement, other types of electronic advertising generated for instantaneous presentation for particular browser/user profiles, and the like. In many cases, the electronic marketing media are directed to recipients based on profile data (whether user profile or browser profile), internet activity (e.g., browsing history), interest level, social media data (e.g., likes, friends, direct interests, indirect interests/likes via friend connections), in addition to demographic data and geographic data. A marketing server may execute analysis of these data in real time so as to serve an advertisement via a banner iframe, present an advertisement via a social media platform, to prepare a direct communication. This personalized marketing that is based on real time data (e.g., based on browsing data from a current browser session, email inbox content of the last hour or day) requires rapid real-time analysis of attributes that may number in the hundreds, thousands or tens of thousands. This level of complexity is best served using trained ML models to execute the analyses.

Similarly, generating an outcome value from a sequence of events of an electronic marketing campaign is practical using a trained ML model given the sheer volume of data to be analyzed. For example, depending on the interests of the marketer executing the campaign, different user responses to different types of electronic campaign events may be weighted differently when calculating an outcome value. Furthermore, different types of electronic campaign events have different types of responses, each of which may be weighted differently when calculating an outcome value. For example, a conversion may be weighted different than a user engagement (e.g., opening an email, clicking a link). A positive user engagement weight may be reduced or changed upon detecting that a vehicle for the user engagement has been deleted or moved to a trash folder. Similarly, a duration of an impression may be weighted proportional to a time that a user is on a page or screen with a presented advertisement. In other examples, contributions to an outcome value for multiple events that are presented in a coordinated fashion to an individually identified same user or browser via multiple different channels may be analyzed according to different criteria and contribute to an outcome value according to different weights.

Any of the preceding examples, and more, may be present in different combinations, further complicating the analysis while increasing the accuracy, precision, and sophistication of any determined outcomes (presuming the data may be analyzed). Furthermore, a single corporate entity may be coordinating tens, hundreds, or thousands of campaigns simultaneously. All of the data for executing the many campaigns and analyzing results from the many different campaigns may require real time analysis in parallel with one another. In some cases, successive campaigns are related to one another (e.g., pursuing a same demographic population or marketing a same set of products) and will be analyzed in coordination with one another (e.g., to determine individual event attributions to conversions). Similarly, the above illustration also illustrates the inadequacy of traditional game theory models (e.g., Shapley Value Theory) which may require values for all possible subsets (i.e., combinations) of entities. These analyses, firmly rooted in internet technology, are generally too complicated for most analytical tools and are best served by a trained ML model.

The method 200 continues with, having identified multiple sequences of entities, identifying a first entity sequence from the set of multiple sequences (operation 216). The identified first entity sequence may be associated with a corresponding first outcome value and may include an entity of interest (a “target entity”) whose individual contribution to the outcome value is desired to be known. In a specific illustration, a marketing agent may wish to know the individual contribution of a particular mass email event to an overall conversion rate for a multi-event marketing campaign.

The identification of the first entity sequence in the operation 216 may be based on any criteria. For example, the first entity sequence may be selected from a set of multiple other entity sequences because the first entity sequence includes a particular target entity that is of interest. In one illustration, the target entity may employ a technique or involve an event that is common to other sequences and the effectiveness of the event is under analysis. Other selection criteria for an entity sequence that includes a target entity are also possible.

The method then identifies an outcome attribution value corresponding to the target entity (operation 220). In this way, a system executing the method 200 may identify an individual contribution associated with the target entity toward the outcome value associated with the sequence as a whole. In the illustration shown, a system may perform the operation 220 via sub-operations 224, 228, 232, and 236, each of which are described below in more detail.

The system may identify a sub-sequence of data entities within the first entity sequence (operation 224). This sub-sequence may include at least two entities including and/or in addition to the target entity. In some embodiments, because order of the entities is a factor that the present analysis accounts for, the target entity may be the final entity in the sub-sequence. That is, the non-target entities may precede the target entity in the sub-sequence. In different examples, the non-target entities may follow the target entity in the sub-sequence. This order may correspond to the actual order of events (e.g., in time) corresponding to the data entities. In other examples, the order of entities may correspond to some other ordering criteria, such as by a rank, an importance level, a magnitude of one or more values, an alphabetic ordering, among others.

The sub-sequence of the first entity sequence may include all of the entities in the first sequence prior to the target entity. In some examples, the target entity is a last entity in the sequence. While not necessary for the execution of the method 200, this is a conveniently illustrated situation in which entities preceding the last entity are identified as associated with an outcome attribution value using a second sequence. The outcome attribution value for the subsequence preceding the target entity may then be removed from the outcome value for the first sequence, thereby identifying the outcome attribution value for the target entity by isolation.

In other examples, the target entity need not be the last entity in the sub-sequence. For example, a target entity may appear as the first entity in the sub-sequence. In other examples, the target entity may be located at any position from the first entity in the sub-sequence to the last entity in the sub-sequence. However, for convenience of explanation, the following description assumes the target entity is preceded by the other entities in the sequence.

The selection of a particular sub-sequence within the first entity sequence may use any criteria. However, turning to the operation 228, the selected sub-sequence is most convenient if it has entities that also appear in a second entity sequence. More specifically, the system executing the method 200 may identify a second entity sequence that it determines has the same entities as the sub-sequence of the first entity sequence.

In some examples, the system determines that the entities in the sub-sequence of the first sequence and the entities in the second sequence correspond to (or are identical to) one another using any of a variety of comparison techniques. In one illustration, the system may compare vector representations of the sub-sequence of the first sequence and the second sequence using a cosine similarity analysis. In one illustration, a cosine of 1 indicates that the compared sub-sequence and second sequence are identical to one another. In another example, the system may allow for minor differences that may not be significant enough to influence the analysis by setting a minimum threshold cosine value that still indicates a high degree of similarity. For example, a threshold of 0.9 or 0.95 may be sufficient for the system to determine that the compared sub-sequence and second sequence are sufficiently similar to complete the analysis. Examples of differences that might account for a similarity value less than one but still high enough to continue performing the method 200 are, for non-limiting illustration purposes only, difference in date/time metadata, parameter name typographic differences, or even differences in parameter values that are small enough to be disregarded (e.g., less than 5%, less than 1%).

The system then determines an outcome value associated with the second entity sequence (operation 232). To distinguish the outcome value of the second entity sequence, which is associated with only a portion of the entities in the first entity sequence (i.e., the sub-sequence), this outcome value of the second entity sequence is described as an outcome attribution value.

The above processes may be repeated in some examples for the same target entity but using different sub-sequences of the first entity and different analogous sequences with outcome values. Using different sub-sequences that include the target entity, and therefore different alternative sequences from the plurality of sequences that have identical entities to these different sub-sequences, may identify different levels of contribution by the target entity under different circumstances. As indicated above, the techniques described herein take into account entity order for the practical reason that order can influence the effectiveness (i.e., an outcome attribute value) of an individual entity. Similarly, the contribution of an individual entity may differ depending on the other entities in the sequences. Using the different sub-sequences and corresponding entities may identify the different individual contribution of the target entity to an overall outcome sequence value under different conditions (e.g., different entity orders, different types of entities in a sequence). The use of different sequences and sub-sequences is described below in more detail of the operations 240-252.

The system may identify the outcome attribution value of the second entity sequence using any of the techniques described above. For example, the outcome attribution value may be identified as a label or particular value in a vector representation of the second entity sequence. In another example, the outcome attribution value may occupy a particular column in a row/table data when the second entity sequence is stored in a table data structure (e.g., in a relational database table).

Once identified, the system may remove the outcome attribution value associated with the second entity sequence from the outcome value associated with the first sequence (operation 236). This transaction thereby isolates the individual contribution of the target entity of the first sequence so that the individual contribution of the target entity is known.

While the method 200 is described as including only a single second entity sequence, a single first subsequence, and a single target entity, the method 200 may be applied to multiple target entities within a particular sequence. This is accomplished by first applying the method 200 repeatedly and in parallel to identify multiple sub-sequences of a first sequence of entities, one or more of which contains a corresponding target entity. Then, a system applies the method 200 to identify multiple separate sequences or sub-sequences of entities (1) for which outcome values are known and (2) which correspond to one of the sub-sequences of the first sequence. These sub-sequences may then be used to identify the outcome attribution values for one or more of the target entities in the first sequence.

When applying the method 200 in this way to identify outcome attribution values for multiple target entities in a sequence of entities, the system may involve the use of one or more trained ML models and/or pipelines of trained ML models. The trained ML models may execute, using for example deep learning models, the analyses to quickly and accurately identify sequences and sub-sequences that may be analyzed successfully according to the method 200. In this way, multiple target entities within a sequence may be analyzed using different, but analogous entities for which outcome attribution values are known.

In other examples, the method 200 may be adapted to identify an outcome attribution value for a target entity that is both preceded by a first sub-sequence and followed by a second sub-sequence in the first sequence. In this scenario, one or more additional entity sequences may be identified that correspond to the first sub-sequence and the second sub-sequence. Outcome attribution values associated with the one or more additional entity sequences may be removed from the outcome value, thereby isolating the attribute contribution value associated with the target entity.

The system may periodically repeat the method 200 on the same entities as new entity values are accumulated, as indicated by the dashed line connecting the operation 236 to the operation 204 in FIG. 2.

In some examples, the system may optionally identify one or more additional outcome attribution values corresponding to the target entity using different entity sequences and their corresponding outcome values (operation 240). As mentioned above, computing these additional outcome attribution values for a target entity using different entity sequences may further refine or otherwise improve the accuracy of target entity’s outcome attribution value by taking into account an order of entities (e.g., chronological or otherwise), different types of entities (corresponding to different types of events), and other similar variabilities.

In some examples, the operation 240 may be executed by first identifying a third entity sequence from the plurality of entity sequences that is associated with its respective third outcome value and that also includes the target entity (operation 244). The operation 244 is analogous to the operation 224 and may use analogous techniques to those described above. Similarly, using techniques described above in the operation 220 (and sub-operations 224-236), the system may compute an additional outcome attribution value corresponding to the contribution of the target entity (operation 248).

The operation 240 may be repeated any number of times. For example, the operation 240 may be repeated using additional, different entity sequences that include the target entity. These additional different entity sequences may capture different types of entities, entities corresponding to different events, different chronological orders of entities, and combinations thereof.

The process 200 may continue by optionally computing an average outcome attribution value (operation 252). The system may generate the average outcome attribution value based on the outcome attribution value for the target entity generated in the operation 236 and any additional outcome attribution values for the target entity generated in the operation 240. In some examples, the average outcome attribution value may be a simple average. In other examples, the average outcome attribution value may be generated using a weighted average scheme. For example, the system may apply weights to individual outcome attribution values based on a number of constituent entities in the sequence, a location of the target entity within the sequence (e.g., applying more or less weights based on a location of the target entity in a chronology), or other factors.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

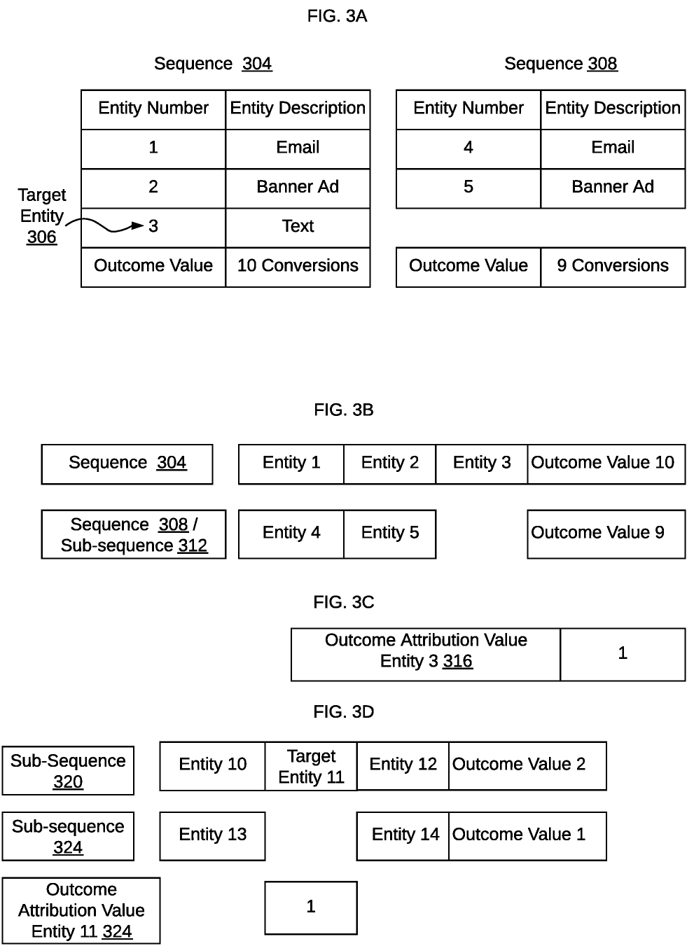

FIGS. 3A-3D illustrate an example of entities on which the operations of the method 200 are executed. FIG. 3A illustrates a sequence 304 of Entities 1, 2, 3, and their corresponding descriptions. In this example, Entity 1 corresponds to an email distribution in a marketing campaign, Entity 2 corresponds to a banner advertisement event, and Entity 3 corresponds to a text message event. Entity 3 is indicated as a target entity 306. The operations of the method 200 are applied to determine the individual contribution of the target entity 306 toward the collective outcome of the sequence 304 (i.e., the outcome attribution value of the target entity 306).

FIG. 3A also illustrates a sequence 308 of Entities 4 and 5. Entity 4 corresponds to an email event and Entity 5 corresponds to a banner advertisement event.

The outcome value of the sequence 304 is 10 conversions and the outcome value of the sequence 308 is 9 conversions. These outcome values are also illustrated in FIG. 3A.

Consistent with the descriptions of FIGS. 1 and 2, the sequence 308 is a sub-sequence of the sequence 304. That is, Entities 4 and 5 of the sequence 308 are the same as Entities 1 and 2 of the sequence 304.

FIG. 3B arranges the information previously described in the context of FIG. 3A in a way that emphasizes the fact that the sequence 308 may be described alternatively as a sub-sequence 312 of the sequence 304. As shown in FIG. 3B, the target entity 306 (Entity 3 from sequence 304) is the only entity from the sequence 304 that is absent from the sub-sequence 312.

Turning now to FIG. 3C, the method 200 is applied to the sequence 304 and the sub-sequence 312 by removing the outcome value of the sub-sequence 312 from the outcome value of the sequence 304. Upon executing this aspect of the method 200, the outcome attribution value for Entity 3 is 1 conversion.

FIG. 3D illustrates an abbreviated example similar to that depicted in FIGS. 3A-3C except for the location of the target entity. As indicated above, a target entity may be at any location in a sub-sequence. FIG. 3D illustrates this point. Sub-sequence 320 includes Entity 10, Target Entity 11, and Entity 12. The sub-sequence 320 has an outcome value of 2. The sub-sequence 324 includes Entity 13 which is analogous to Entity 10 of the sub-sequence 320, and Entity 14 which is analogous to Entity 12 of the sub-sequence 320. The outcome value of the sub-sequence 324 is 1. By applying the techniques described above, the system determines that the outcome attribution value for the target entity 11 is 1.

The embodiments in the examples illustrated in FIGS. 3A-3D, or in any of the embodiments described herein, may encompass many different types of entities and/or sequences. In one illustration, a sequence may comprise entities corresponding to a first email, followed by a second email, followed by a banner advertisement, and finally followed by a promotional notice. Outcome values may include one or more types of user engagement with any of the electronically communicated entities (e.g., opening an email, engaging a promotional link or banner advertisement, purchasing a product). Embodiments described herein may determine the proportional contribution to a positive outcome (e.g., purchasing a product) that each of these electronically communicated entities contributed.

While the preceding embodiment analyzes individual events within a single marketing campaign at a fine level of granularity, the techniques described herein may also be applied to events at a coarser level of granularity. An example of the coarse level of event analysis, each event may be a specific campaign so that the relative contributions of a series of campaigns, such as different types of campaigns (e.g., email, promotional, mixed media) may be analyzed.

In still other embodiments, the techniques may be applied to identify the outcome attribution value associated with one or more parameters within a set of parameters. In one illustration, collections or groups of one or more demographic characteristics may be analyzed for their relative contribution to an outcome value. In still another interesting variation of this fine level of granularity, the techniques may even be applied to measure the negative impact of one or more parameters on an outcome. In one illustration, the outcome value analyzed may be a number of recipients and the parameters may include demographic characteristics, communication type (e.g., email, promotional link, physical mailing).

Other examples of use cases include determining relative contributions of different communication channels. In one illustration, the techniques may determine different outcome attribution values for different social media platforms, text versus email versus adaptive advertising), and the like. In another illustration, the techniques may be applied to determine individual contributions of different types of marketing campaigns type or classes of campaigns (e.g., flash sales campaigns vs. extended-period campaigns; bulk campaigns vs. personalized campaigns). Similarly, the techniques may be applied to determine the outcome attribution level associated with different population segments.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider’s applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

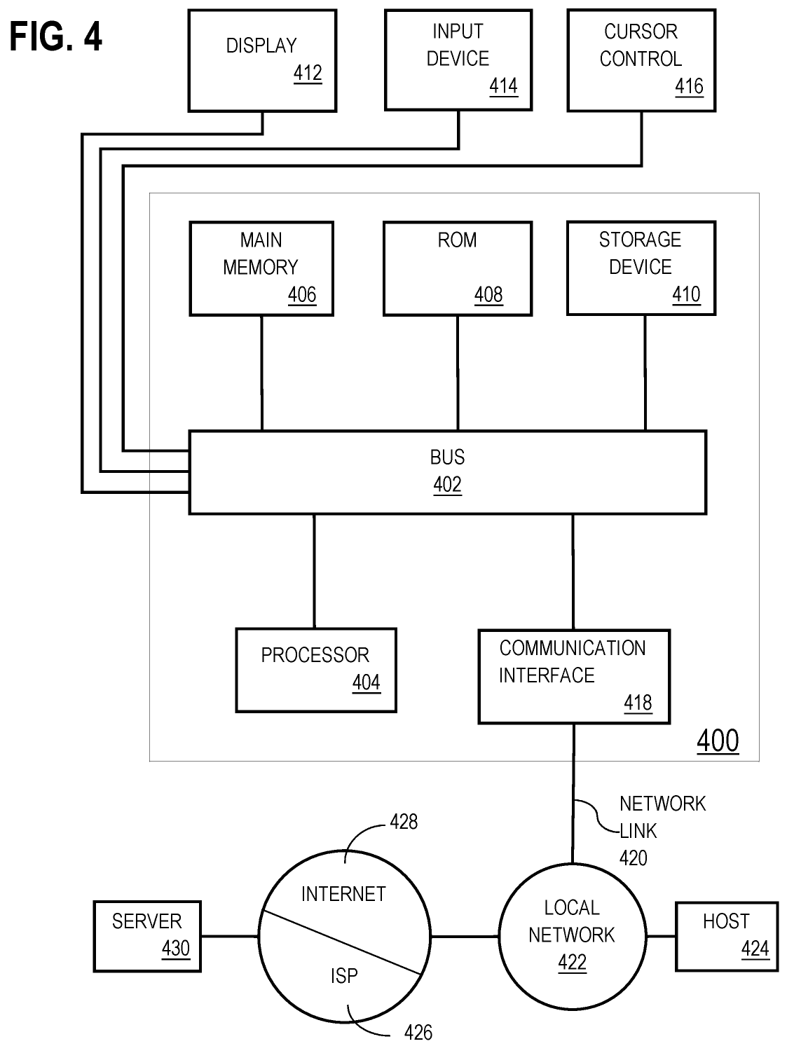

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
identify a plurality of entity sequences, wherein each particular entity sequence of the plurality of entity sequences:
comprises one or more entities; and
is associated with a respective outcome value representing one or more detected outcomes of the particular entity sequence;
identifying a first entity sequence, of the plurality of entity sequences, that is (a) associated with a first outcome value and (b) comprises a target entity as a last entity in the first entity sequence;
identifying a first outcome attribution value corresponding to an attribution of the target entity toward the first outcome value associated with the first entity sequence at least by:
identifying a first sub-sequence of the first entity sequence, wherein the first sub-sequence comprises two or more entities, and wherein the first sub-sequence comprises entities in the first entity sequence prior to the target entity;
determining that the first sub-sequence of the first entity sequence is identical to a second entity sequence in the plurality of entity sequences;
identifying a second outcome value associated with the second entity sequence; and
based on the second outcome value and the first outcome value, computing the first outcome attribution value corresponding to the target entity.

2. The media of claim 1, further comprising:
identifying a third entity sequence, of the plurality of entity sequences, that is (a) associated with a third outcome value and (b) comprises the target entity;
computing a second outcome attribution value corresponding to the target entity’s attribution toward the third outcome value associated with the third entity sequence; and
computing an average of outcome attribution values corresponding to the target entity’s attribution toward outcome values to generate an overall attribution value for the target entity, the outcome attribution values comprising the first outcome attribution value and the second outcome attribution value.

3. The media of claim 1, further comprising:
identifying a third entity sequence, of the plurality of entity sequences, that is (a) associated with a third outcome value and (b) comprises a particular entity;
identifying a second outcome attribution value corresponding to an attribution of the particular entity toward the third outcome value associated with the third entity sequence at least by:
identifying a third sub-sequence of the third entity sequence that does not include the particular entity,
computing a third outcome attribution value corresponding to the third sub-sequence’s attribution toward the third outcome value associated with the third entity sequence;
determining that the third sub-sequence of the third entity sequence is identical to a fourth entity sequence in the plurality of entity sequences;
identifying a fourth outcome value associated with the fourth entity sequence;
identifying a fifth sub-sequence of the third entity sequence that does not include the particular entity, wherein the fifth sub-sequence is different than the fourth entity sequence,
computing a fourth outcome attribution value corresponding to an attribution of the fifth sub-sequence toward the third outcome value associated with the third entity sequence;
determining that the fifth sub-sequence of the third entity sequence is identical to a sixth entity sequence in the plurality of entity sequences;
identifying a fifth outcome value associated with the sixth entity sequence; and
subtracting the fourth outcome value and the fifth outcome value from the third outcome value to compute the second outcome attribution value corresponding to the attribution of the particular entity toward the third outcome value associated with the third entity sequence.

4. The media of claim 1, wherein:
the first entity sequence is represented as a feature vector comprising a plurality of elements, each of which corresponds to an entity of the first entity sequence;
the target entity is represented as a target element of the feature vector; and
the first outcome value is associated with the target entity by associating a label with the target element of the feature vector.

5. The media of claim 4, wherein identifying the first outcome attribution value includes using a trained machine learning model to analyze the first entity sequence and the second entity sequence, wherein using the trained machine learning model further comprises:
training the machine learning at least by:
obtaining historical data comprising a plurality of historical entity sequences, wherein each historical entity sequence comprises a plurality of entities and a corresponding historical outcome value, and wherein each entity comprises (a) a plurality of entity attributes and (b) an associated entity outcome attribution value;
generating a training set comprising the plurality of historical entity sequences, the corresponding historical outcome values, the entity attributes, and the associated entity outcome attribution values;
training the machine learning model to associate a particular historical entity sequence and entity attributes corresponding to each of the entities of the particular historical entity sequence with associated entity outcome attribution values corresponding to the entities of the particular historical entity sequence; and
applying the trained machine learning model to the first entity sequence and the second entity sequence to determine the first outcome attribution value corresponding to the target entity.

6. The media of claim 1, wherein an order of the entities in the first sub-sequence of the first entity sequence is identical to that of a second order of the entities in the second entity sequence.

7. The media of claim 1, wherein:
the target entity comprises a set of attributes corresponding to an individual event in a marketing campaign; and
the one or more entities of the first sequence of entities each comprise corresponding sets of attributes corresponding to a collection of events in a marketing campaign.

8. The media of claim 1, wherein:
the target entity comprises a marketing campaign; and
the plurality of entities in the first sequence correspond to a plurality of marketing campaigns.

9. The media of claim 1, wherein each of the entity sequences in the plurality comprises a corresponding plurality of chronologically arranged entities.

10. The media of claim 9, wherein each outcome value corresponding to each of the plurality of entity sequences is based the corresponding chronological arrangement of the entities in the corresponding entity sequence.

11. A method comprising:
identify a plurality of entity sequences, wherein each particular entity sequence of the plurality of entity sequences:
comprises one or more entities; and
is associated with a respective outcome value representing one or more detected outcomes of the particular entity sequence;
identifying a first entity sequence, of the plurality of entity sequences, that is (a) associated with a first outcome value and (b) comprises a target entity as a last entity in the first entity sequence;
identifying a first outcome attribution value corresponding to an attribution of the target entity toward the first outcome value associated with the first entity sequence at least by:
identifying a first sub-sequence of the first entity sequence, wherein the first sub-sequence comprises two or more entities, and wherein the first sub-sequence comprises entities in the first entity sequence prior to the target entity;
determining that the first sub-sequence of the first entity sequence is identical to a second entity sequence in the plurality of entity sequences;
identifying a second outcome value associated with the second entity sequence; and
based on the second outcome value and the first outcome value, computing the first outcome attribution value corresponding to the target entity.

12. The method of claim 11, further comprising:
identifying a third entity sequence, of the plurality of entity sequences, that is (a) associated with a third outcome value and (b) comprises the target entity;
computing a second outcome attribution value corresponding to the target entity’s attribution toward the third outcome value associated with the third entity sequence; and
computing an average of outcome attribution values corresponding to the target entity’s attribution toward outcome values to generate an overall attribution value for the target entity, the outcome attribution values comprising the first outcome attribution value and the second outcome attribution value.

13. The method of claim 11, further comprising:
identifying a third entity sequence, of the plurality of entity sequences, that is (a) associated with a third outcome value and (b) comprises a particular entity;
identifying a second outcome attribution value corresponding to an attribution of the particular entity toward the third outcome value associated with the third entity sequence at least by:
identifying a third sub-sequence of the third entity sequence that does not include the particular entity,
computing a third outcome attribution value corresponding to the third sub-sequence’s attribution toward the third outcome value associated with the third entity sequence;
determining that the third sub-sequence of the third entity sequence is identical to a fourth entity sequence in the plurality of entity sequences;
identifying a fourth outcome value associated with the fourth entity sequence;
identifying a fifth sub-sequence of the third entity sequence that does not include the particular entity, wherein the fifth sub-sequence is different than the fourth entity sequence,
computing a fourth outcome attribution value corresponding to an attribution of the fifth sub-sequence toward the third outcome value associated with the third entity sequence;
determining that the fifth sub-sequence of the third entity sequence is identical to a sixth entity sequence in the plurality of entity sequences;
identifying a fifth outcome value associated with the sixth entity sequence; and
subtracting the fourth outcome value and the fifth outcome value from the third outcome value to compute the second outcome attribution value corresponding to the attribution of the particular entity toward the third outcome value associated with the third entity sequence.

14. The method of claim 11, wherein:
the first entity sequence is represented as a feature vector comprising a plurality of elements, each of which corresponds to an entity of the first entity sequence;
the target entity is represented as a target element of the feature vector; and
the first outcome value is associated with the target entity by associating a label with the target element of the feature vector.

15. The method of claim 14, wherein identifying the first outcome attribution value includes using a trained machine learning model to analyze the first entity sequence and the second entity sequence, wherein using the trained machine learning model further comprises:
training the machine learning at least by:
obtaining historical data comprising a plurality of historical entity sequences, wherein each historical entity sequence comprises a plurality of entities and a corresponding historical outcome value, and wherein each entity comprises (a) a plurality of entity attributes and (b) an associated entity outcome attribution value;
generating a training set comprising the plurality of historical entity sequences, the corresponding historical outcome values, the entity attributes, and the associated entity outcome attribution values;
training the machine learning model to associate a particular historical entity sequence and entity attributes corresponding to each of the entities of the particular historical entity sequence with associated entity outcome attribution values corresponding to the entities of the particular historical entity sequence; and
applying the trained machine learning model to the first entity sequence and the second entity sequence to determine the first outcome attribution value corresponding to the target entity.

16. The method of claim 11, wherein an order of the entities in the first sub-sequence of the first entity sequence is identical to that of a second order of the entities in the second entity sequence.

17. The method of claim 11, wherein:
the target entity comprises a set of attributes corresponding to an individual event in a marketing campaign; and
the one or more entities of the first sequence of entities each comprise corresponding sets of attributes corresponding to a collection of events in a marketing campaign.

18. The method of claim 11, wherein:
the target entity comprises a marketing campaign; and
the plurality of entities in the first sequence correspond to a plurality of marketing campaigns.

19. The method of claim 11, wherein each of the entity sequences in the plurality comprises a corresponding plurality of chronologically arranged entities.

20. The method of claim 19, wherein each outcome value corresponding to each of the plurality of entity sequences is based the corresponding chronological arrangement of the entities in the corresponding entity sequence.
